(19) United States
(12) Patent Application Publication
(10) Pub. No.: US 2018/0086585 A1
(43) Pub. Date: Mar. 29, 2018

(54) IMAGE FORMING APPARATUS AND RECORDING-MEDIA SUPPLY DEVICE

(71) Applicant: FUJI XEROX CO., LTD., Tokyo (JP)

(72) Inventor: Takashi OGINO, Kanagawa (JP)

(73) Assignee: FUJI XEROX CO., LTD., Tokyo (JP)

(21) Appl. No.: 15/591,245

(22) Filed: May 10, 2017

(30) Foreign Application Priority Data
Sep. 26, 2016 (JP) 2016-186520

(51) Int. Cl. B65H 29/52; G03G 15/00

(52) U.S. Cl. CPC B65H 29/52; G03G 15/6529; B65H 2801/06; B65H 2404/521; B65H 2401/211

(57) ABSTRACT

An image forming apparatus includes an image forming unit that forms an image and a guiding member that guides a sheet on which the image has been formed by the image forming unit. At least one of irregularities and holes are formed on or in a surface of the guiding member that guides the sheet.

### CROSS-REFERENCE TO RELATED APPLICATIONS

This application is based on and claims priority under 35 USC 119 from Japanese Patent Application No. 2016-186520 filed Sep. 26, 2016.

### BACKGROUND

### Technical Field

The present invention relates to an image forming apparatus and a recording-media supply device.

### SUMMARY

According to an aspect of the invention, there is provided an image forming apparatus including an image forming unit that forms an image and a guiding member that guides a sheet on which the image has been formed by the image forming unit. At least one of irregularities and holes are formed on or in a surface of the guiding member that guides the sheet.

### BRIEF DESCRIPTION OF THE DRAWINGS

Exemplary embodiments of the present invention will be described in detail based on the following figures, wherein:

FIG. 1 is a diagram illustrating the configuration of an image forming apparatus used in an exemplary embodiment of the present invention;

FIG. 2 is an enlarged view illustrating a portion of a guide surface of a guiding member used in the exemplary embodiment of the present invention;

FIG. 3 is a perspective view illustrating a state where the guiding member, which is used in the exemplary embodiment of the present invention, guides a sheet as viewed from the direction of arrow A in FIG. 1;

FIG. 4A, FIG. 4B, FIG. 4C, and FIG. 4D are diagrams illustrating a first example, a second example, a third example, and a fourth example, respectively, of a hole formed in the guiding member; and

FIG. 5 is a perspective view illustrating a state where the guiding member according to a comparative example guides a sheet.

### DETAILED DESCRIPTION

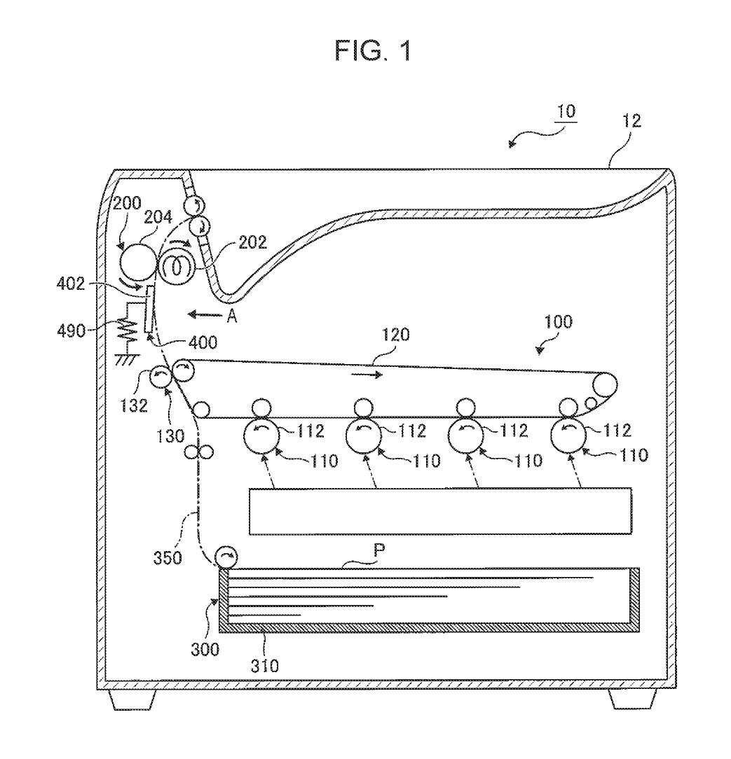

An exemplary embodiment of the present invention will be described below with reference to the drawings. FIG. 1 illustrates an image forming apparatus 10 according to the exemplary embodiment of the present invention. The image forming apparatus 10 includes an image forming apparatus body 12. An image forming unit 100, a fixing device 200, a sheet-feeding device 300, and a guiding member 400 are disposed in the image forming apparatus body 12. In addition, a transport path 350 along which sheets P, each of which is a recording medium, are to be transported is formed in the image forming apparatus body 12.

For example, the image forming unit 100 employs an electrophotographic system and forms images on the sheets P. For example, the image forming unit 100 includes four image forming units 110. Each of the four image forming units 110 includes a photoconductor drum 112, which is an image carrier, and toner images of yellow, magenta, cyan, and black are formed on the surfaces of the photoconductor drums 112.

The image forming unit 100 further includes an intermediate transfer belt 120. Toner images formed on the surfaces of the four photoconductor drums 112 are transferred onto the intermediate transfer belt 120.

The image forming unit 100 includes a second transfer device 130, and the second transfer device 130 includes a second transfer roller 132 and a counter roller 134. A transfer bias is applied to the second transfer roller 132 in such a manner that toner images that have been transferred to the intermediate transfer belt 120 are electrostatically transferred onto one of the sheets P. The counter roller 134 faces the second transfer roller 132 and is pressed against the second transfer roller 132 with the intermediate transfer belt 120 interposed therebetween.

The fixing device 200 fixes toner images, which have been formed on a surface of one of the sheets P by the image forming unit 100, onto the sheet P by using, for example, heat and pressure. The fixing device 200 includes a heating roller 202, which includes a heat source therein, and a pressing roller 204, which presses one of the sheets P against the heating roller 202.

The sheet-feeding device 300 feeds the sheets P, which are stacked on top of one another in a sheet-accommodating unit 310, toward the image forming unit 100.

The guiding member 400 guides one of the sheets P. More specifically, the guiding member 400 guides one of the sheets P, to which toner images have been transferred by the second transfer device 130, to a fixing region that is formed as a result of the heating roller 202 and the pressing roller 204 being in contact with each other and in which toner images are fixed onto one of the sheets P. For example, the guiding member 400 has a plate-like shape and has a guide surface 402, which is a surface with which one of the sheets P is brought into contact and a surface that guides one of the sheets P.

The guiding member 400 is formed of a conductive member made of, for example, a metal. By using a metal material for the guiding member 400, the guiding member 400 may be manufactured at a lower cost and may be further easily processed compared with the case of using other conductive materials.

More specifically, as the material of the guiding member 400, for example, a metal that has a specific resistance of about 10⁻⁵ Ω·cm and is used in a precision machine may be used, and examples of such a metal include iron and steel. Since the guiding member 400 needs to have a conductive surface, a metal that has a specific resistance of about 10¹² Ω·cm and that is coated with an insulating film, such as an anodic oxide coating, is not usable as the material of the guiding member 400, even if it is a metal. Note that details of the guiding member 400 will be described later.

The guiding member 400 is provided with a resistor 490.

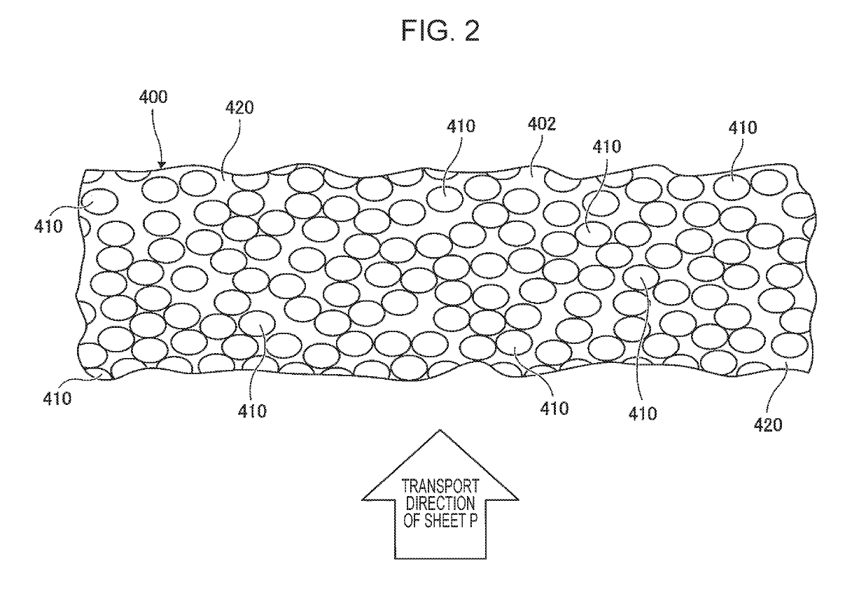

FIG. 2 illustrates a portion of the guide surface 402 of the guiding member 400 in an enlarged manner. Irregularities 404 are formed on the guide surface 402. More specifically, projections 410 each having a substantially oval shape are formed on the guide surface 402, and portions of the guide surface 402 on which the projections 410 are not formed are depressions 420 each having a height lower than that of each of the projections 410. The irregularities 404 of the guide surface 402 may be formed by, for example, press working, laser processing, or etching.

By forming the irregularities 404 on the guiding member 400, the area of one of the sheets P that is brought into contact with the guide surface 402 is reduced, and the sheet P is less likely to be electrostatically attracted to the guiding member 400. Therefore, it is unlikely that a failure during transportation of the sheet P as a result of the sheet P being attracted to the guiding member 400 will occur.

The irregularities 404 are arranged on the guide surface 402 in a random manner. Thus, it is less likely that a failure during transportation of one of the sheets P as a result of an end portion of the sheet P coming into contact with the projections 410 will occur compared with the case where the irregularities 404 are arranged in a regular manner. Examples of cases where the irregularities 404 are arranged in a regular manner are as follows: a case where the irregularities 404 are arranged at a certain pitch, a case where the irregularities 404 are formed such that some of the projections 410 are located in a straight line, and a case where the irregularities 404 are formed in a grid-like pattern.

Regarding the irregularities 404, it is desirable that the diameter of each of the projections 410 be 1.5 mm or about 1.5 mm or larger.

It is desirable that the diameter of each of the projections 410 of the irregularities 404 be 4 mm or about 4 mm or smaller.

It is desirable that the ratio of the area of the projections 410 of the irregularities 404 to the area of the guide surface 402 be 40% or about 40% or higher.

It is desirable that the ratio of the area of the projections 410 of the irregularities 404 to the area of the guide surface 402 be 75% or about 75% or lower.

It is desirable that the height of each of the projections 410 of the irregularities 404 be 1 mm or about 1 mm or larger.

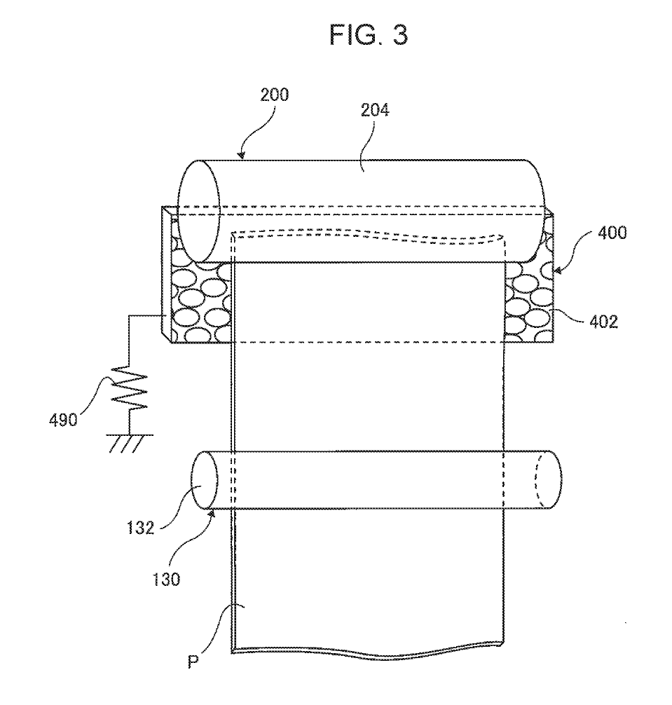

FIG. 3 illustrates a state where the guiding member 400 guides one of the sheets P. According to the exemplary embodiment, the sheet P is not attracted to the guide surface 402 of the guiding member 400, and a specific portion of the sheet P does not protrude. In addition, wrinkles are not generated in the sheet P.

In the above description, although a case is described in which the irregularities 404 are the projections 410 on the guide surface 402 of the guiding member 400, the irregularities 404 may be recesses formed in the guide surface 402 of the guiding member 400 or may be both the projections 410 and recesses.

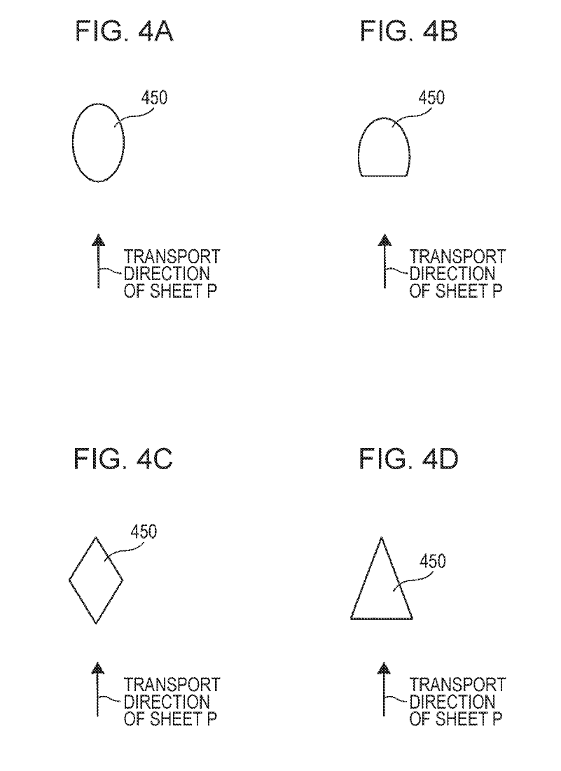

In the above description, although a case is described in which the irregularities 404 are formed on the guide surface 402 of the guiding member 400, for example, holes 450 (see FIGS. 4A to 4D) each extending through the guiding member 400 may be formed in the guide surface 402 of the guiding member 400 instead of or in addition to the irregularities 404.

FIG. 4 illustrates examples of holes to be formed in the guide surface 402 of the guiding member 400. The hole 450 illustrated in FIG. 4A as an example has a substantially oval shape. The hole 450 illustrated in FIG. 4B as an example has a substantially oval segment shape. The hole 450 illustrated in FIG. 4C as an example has a diamond shape. The hole 450 illustrated in FIG. 4D as an example has a triangular shape.

In each of the shapes of the holes 450 described above as examples, the front portion in the transport direction of the sheets P is not formed in a linear shape. Therefore, it is less likely that the leading end portion of one of the sheets P will become caught in the holes 450 compared with the case of a technology for forming the front portion of each of the holes 450 in the transport direction of the sheets P into a linear shape.

In the case where the holes 450 are formed in the guide surface 402 of the guiding member 400, in a similar manner to the above-described irregularities 404, the holes 450 are arranged in the guide surface 402 in a random manner.

It is desirable that the size of each of the holes 450 be 1.5 mm or about 1.5 mm or larger.

It is desirable that the size of each of the holes 450 be 4 mm or about 4 mm or smaller.

It is desirable that the ratio of the area of the holes 450 to the area of the guide surface 402 be 40% or about 40% or higher.

It is desirable that the ratio of the area of the holes 450 to the area of the guide surface 402 be 75% or about 75% or lower.

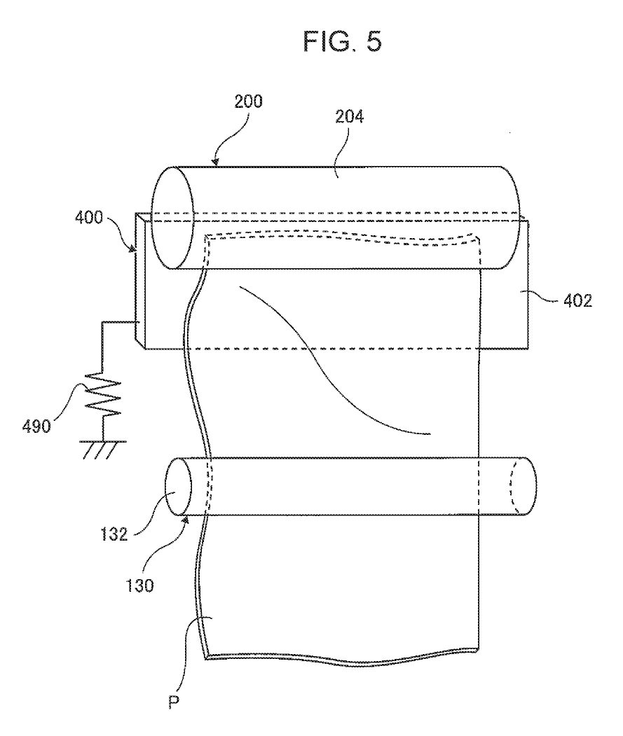

FIG. 5 is a perspective view illustrating a state where the guiding member 400 according to a comparative example guides one of the sheets P. In the above-described exemplary embodiment, at least one of the irregularities 404 and the holes 450 are formed on or in the guide surface 402 of the guiding member 400. In contrast, in the comparative example, neither the irregularities 404 nor the holes 450 are formed in the guide surface 402 of the guiding member 400.

Thus, according to the present modification, it is more likely that one of the sheets P will be electrostatically attracted to the guide surface 402 of the guiding member 400 compared with the above-described exemplary embodiment. In this case, a situation in which the entire sheet P is uniformly attracted to the guiding member 400 rarely occurs, and in general, the attraction force of the sheet P to the guiding member 400 varies in accordance with position. In addition, in the case where the sheet P is unevenly attracted to the guiding member 400, there is a possibility that the sheet P will be inclined and a possibility that a protrusion (trough) will be generated in the sheet P as illustrated in FIG. 5.

Also in the present comparative example, the resistor 490 is provided in such a manner that one of the sheets P will not be electrostatically attracted to the guiding member 400. However, the resistance of the resistor 490 has a limitation because of, for example, the manufacturing costs and the difficulty of procurement. Thus, even if the resistor 490 is provided, it is difficult to reduce the probability that one of the sheets P will be electrostatically attracted to the guiding member 400.

A sheet P is most likely to be attracted to the guiding member 400 in the case where the sheet P has low rigidity. More specifically, a sheet P having a flexural rigidity of less than 3.0 gf is most likely to be attracted to the guiding member 400.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
an image forming unit configured to form an image; and
a guiding member configured to guide a sheet on which the image has been formed by the image forming unit,
wherein holes are formed on or in a surface of the guiding member,
wherein the holes have shapes, and
wherein a front portion of each one of the shapes, in a transport direction of the sheet, is non-linear in shape.

2. The image forming apparatus according to claim 1,
wherein the holes are arranged on the guiding member in a random manner.

3. The image forming apparatus according to claim 2,
wherein each of the holes has a diameter of about 1.5 mm or larger and about 4 mm or smaller,
wherein a ratio of an area of the holes to an area of the surface of the guiding member is about 40% or higher and about 75% or lower, and
wherein each of the holes has a height of about 1 mm or larger.

4. The image forming apparatus according to claim 1,
wherein the holes are arranged in the guiding member in a random manner.

5. The image forming apparatus according to claim 4,
wherein each of the holes has a diameter of about 1.5 mm or larger and about 4 mm or smaller, and
wherein a ratio of an area of the holes to an area of the surface of the guiding member is about 40% or higher and about 75% or lower.

6. The image forming apparatus according to claim 1,
wherein the guiding member is made of a metal.

7. The image forming apparatus according to claim 2,
wherein the guiding member is made of a metal.

8. The image forming apparatus according to claim 3,
wherein the guiding member is made of a metal.

9. The image forming apparatus according to claim 4,
wherein the guiding member is made of a metal.

10. The image forming apparatus according to claim 5,
wherein the guiding member is made of a metal.

11. A transport device comprising:
a transport unit configured to transport a sheet in a transport direction; and
a guiding member configured to the sheet,
wherein holes are formed on or in a surface of the guiding member,
wherein the holes have shapes, and
wherein a front portion of each one of the shapes, in a transport direction of the sheet, is non-linear in shape.

12. An image forming apparatus comprising:
an image forming unit configured to form an image; and
a guiding member configured to guide a sheet on which the image has been formed by the image forming unit,
wherein at least one of irregularities and holes are formed on or in a surface of the guiding member, and
wherein each of the at least one of irregularities and holes has a diameter of about 1.5 mm or larger and about 4 mm or smaller.

13. An image forming apparatus comprising:
an image forming unit configured to form an image; and
a guiding member configured to guide a sheet on which the image has been formed by the image forming unit,
wherein at least one of irregularities and holes are formed on or in a surface of the guiding member, and
wherein a ratio of an area of the at least one of irregularities and holes to an area of the surface of the guiding member is about 40% or higher and about 75% or lower.

14. The image forming apparatus according to claim 1, wherein each of the holes has a diameter of about 1.5 mm or larger and about 4 mm or smaller.

15. The image forming apparatus according to claim 1, wherein a ratio of an area of the holes to an area of the surface of the guiding member is about 40% or higher and about 75% or lower.

16. The image forming apparatus according to claim 1, wherein each of the holes has a height of about 1 mm or larger.
